(19) United States
(12) Patent Application Publication
(10) Pub. No.: US 2002/0058547 A1
(43) Pub. Date: May 16, 2002

(54) Game machine and prize providing system

(76) Inventors: Masato Yoshida, Kyoto-shi (JP); Koki Imai, Kyoto-shi (JP)

Correspondence Address: DICKSTEIN SHAPIRO MORIN & OSHINSKY LLP, 2101 L STREET NW, WASHINGTON, DC, 20037-1526, US

(21) Appl. No.: 09/967,993

(22) Filed: Oct. 2, 2001

(30) Foreign Application Priority Data
Nov. 15, 2000 (JP) 2000-347975

(51) Int. Cl. G06F 17/00

(52) U.S. Cl. 463/25

(57) ABSTRACT

Abundant kinds of prizes can be treated and a player can select a favorite one among them, and further, a management load of the prizes at an operator side can be reduced. A game machine provides a prize when a player plays a game and satisfies a definite condition, and a play portion where the player plays the game is provided with a sample display portion for displaying samples of plural kinds of prizes which can be acquired by the player, and a notification unit for notifying a management center, which manages actually provided prizes, of an acquired prize chosen by the player when the player obtains a play result in accordance with which the prize can be acquired. A prize providing system includes a forwarding processing portion for performing, when the data of the prize and the destination are notified to the management center from such a game machine, a forwarding processing of the prize on the basis of the data.

### BACKGROUND OF THE INVENTION

1. Field of the Invention

The present invention relates to a game machine for providing a prize when a player plays a game and satisfies a definite condition, and more particularly to a game machine in which a player can select a favorite one among many kinds of prizes, and a prize providing system.

2. Description of the Related Art

As set forth above, in a game machine in which a player can acquire a prize, the game itself has been coupled to the prize. That is, its structure is such that prizes are contained in the game machine and are exhibited, and the prize is held by, for example, a crane, and when it can be well held, it is provided.

However, in the case where the prizes are exhibited in a play portion of the game machine and the prizes are coupled to the game itself, a desired prize is not always selected.

Besides,, articles which can be adopted as the prizes have been restricted. That is, the size, weight, and shape are naturally settled by the kind ot the game, and the number of prizes which can be exhibited is limited, so that the kinds are also limited. Besides, animals and plants can not he treated as the prizes, and if they are treated, it is necessary to treat them carefully in view of protection of animals. Thus, an exhibiting portion dedicated to that must be formed, and the management (care of animals and plants) which an operator (game center side) must perform becomes troublesome.

Further, at the side of the operator (game center) having the game machine in which the prizes can be acquired like this, it takes trouble, for example, many prizes must be managed and are periodically supplemented and arranged.

### SUMMARY OF THE INVENTION

An object of the present invention is therefore to enable treatment of abundant kinds of prizes and to enable a player to select a favorite one among them, and since it is necessary to perform the management of prizes in connection with the self regulation of the trade and the public order and standards of decency, another object thereof is to enable reduction in the management load of an operator aide to that.

Means for achieving the object is a game machine which provides a prize when a player plays a game and satisfies a definite condition, and is characterized in that a play portion where the player plays the game is provided with a sample display portion for displaying samples of plural kinds of prizes which can be acquired by the player, and notification means for notifying a management center, which manages actually provided prizes, of an acquired prize chosen by the player when the player obtains a play result in accordance with which the prize can be acquired.

In this game machine, the player plays the game at the play portion, and in the case where he satisfies the definite condition, he can select a favorite prize among the plural kinds of prizes through the sample display portion provided at the play portion. The selected prize is notified to the management center by the n.otification means, and the player receives the prize through the management center.

The sample display portion does not provide what are displayed, but only displays the samples, so that actual articles may be displayed or may be substituted by photographs or pictures and they may be displayed. In order to display the most possible kinds of prizes, it is appropriate that flat ones are used or an image display device such as a liquid crystal display device is used.

The notification means may be constituted by an electrical structure, a human structure, or a combination of these. For example, in the case where the management center is provided in the same game center as the game center where the game machine is installed, it is simple and good that the notification means is constituted by an exchange ticket automatically issued from the game machine and a delivery operation. In the exchange ticket, the number or the like for identification of the prize chosen by the player is entered, or the prize selected by the player as a result of operation of the game machine is automatically indicated.

In the case where the management center is provided at a place different from the game center, the notification means is constituted by a personal computer and a dedicated line, and necessary information is manually or automatically transmitted.

Like this, in the game machine, the actually provided prizes are not exhibited but the prizes are displayed using the sample display portion, so that many kinds of prizes can be displayed. since the player gaining the right to acquire the prize can select a favorite prize among them, he does not take an unnecessary prize as in the prior art, and can obtain a high feeling of satisfaction. Besides, since it is not necessary for the operator side to hold many prizes and to make suitable supplement and arrangement as in the prior art, the working required for the management is reduced.

Further, since the prize is not exhibited in the game machine, that is, the play portion where the game is played, the play portion of the game machine can also be made compact. Thus, the shape of the whole game machine can be changed on a large scale, and the invention can contribute to obtaining the game machine which arouses player's interest. Moreover, when the size of the game machine is held down, the space in the game center can be effectively used, and the latitude of layout in the game center is also extended.

Incidentally, even if the management center is any of the former examples, the play portion may be provided with selection means forselectinga favorite prize among the plural samples displayed on the sample display portion and outputting a prize selection signal corresponding to the selected prize. The selecting operation of the player becomes easy, a mistake is not easily produced in a later processing, that is, delivery of the prize, and it is convenient in managing the data of the provided prize.

Besides, the play portion may be provided with input means for inputting personal data, and the notification means may be constituted by transmission means for transmitting the personal data inputted and recorded from the input means and data of the prize to be provided through a communication line. It is convenient when the management center is separate from the game center. For example, the personal data of a player's name and the destination and the data of the prize to be provided are electrically inputted and can be transmitted, and in addition, for example, a form is issued from the game machine, information is entered in this form, and can be transmitted by using a facsimile or the like installed as the transmission means.

Another means is a prize providing system characterized by providing a forwarding processing portion for performing, when the personal data and data of the prize to be provided are notified to the management center, a forwarding processing of the prize on the basis of the data. That is, when the personal data and the data of the prize to be provided are inputted to the forwarding processing portion of the management center from the game machine side, forwarding instructions are issued on the basis of the data, the forwarding is executed, and the processing for the forwarding is performed. By this processing, the prize is delivered to, for example, the player's home or an agency such as a convenience store near the home.

That is, when the player plays the game, it is possible to omit the necessity of carrying the acquired prize back as a burden, and he can certainly and easily receive the prize, although not at that place, but in the future.

### BRIEF DESCRIPTION OF THE DRAWINGS

FIG. 1 is an explanatory view of a prize providing system.

FIG. 2 is a block diagram showing a structure of the prize providing system.

FIG. 3 is a control circuit block diagram of a game machine.

FIG. 4 is a prize flowchart.

### DETAILED DESCRIPTION OF THE PREFERRED EMBODIMENTS

Embodiments of the present invention will be hereinafter described with reference to the drawings.

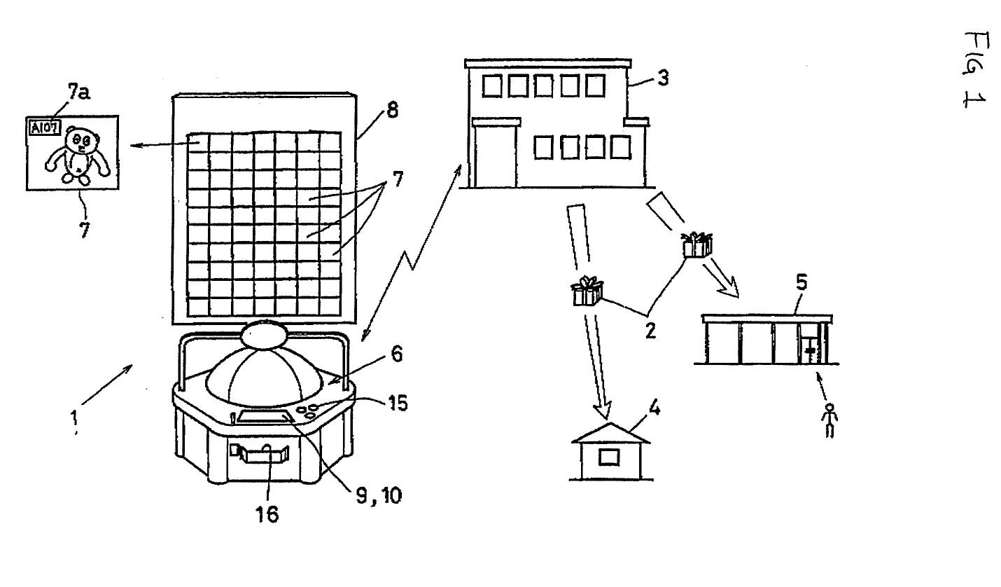

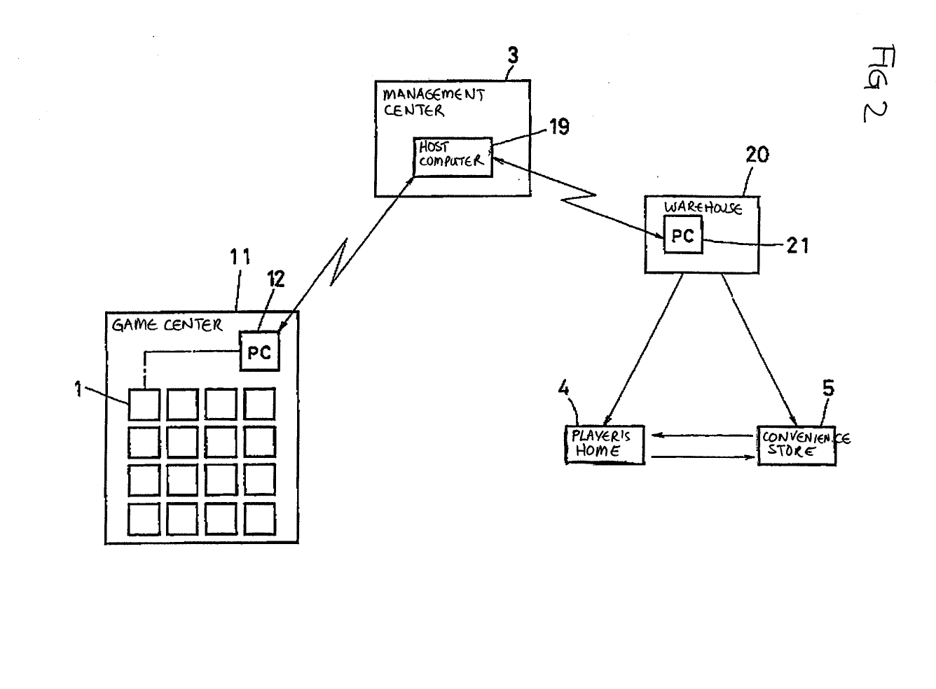

FIG. 1 is an explanatory view showing a game machine 1 in which a prize can be acquired if a definite condition is satisfied as a result of a game, in other words, if a win is gained, and a prize providing system through this game machine 1. FIG. 2 is a block diagram showing a structure of the system.

As shown in these drawings, a prize 2 is not directly acquired from the game machine 1, but is acquired through a management center 3 different from the game machine 1. That is, the management center 3 makes the prize 2 delivered to a player's home 4, and the player receives the prize 2 in the home 4. Besides, the player can receive the prize 2 not in the player, home 4, but in an agency such as a convenience store 5 desired by the player. Further, the player having the right to acquire the prize 2 can select a favorite one among many kinds of prizes 2.

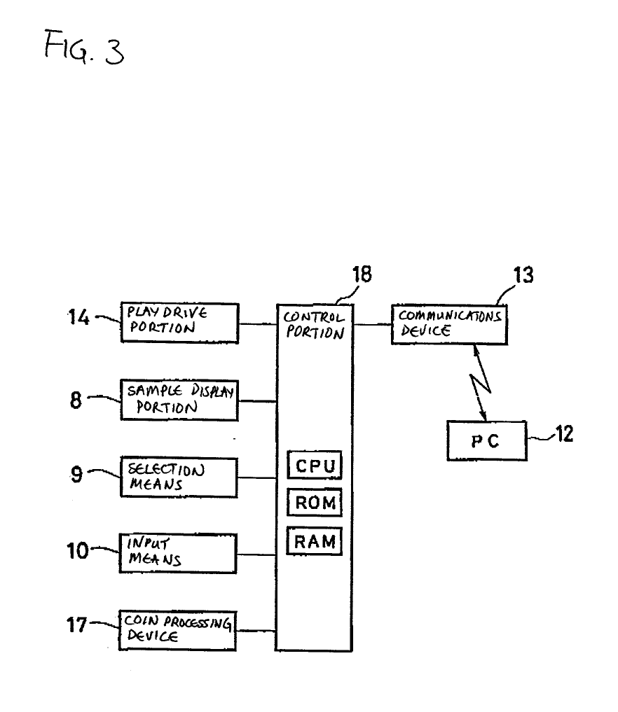

As shown in a control circuit block diagram of FIG. 3, the game machine 1 includes a play portion 6 where a player plays a game, a sample display portion 8 for displaying samples 7 of plural kinds of prizes which the player can acquire, selection means 9 for selecting the favorite prize 2 among the plural kinds of samples 7 displayed on the sample display portion 8, input means 10 for inputting personal data of a player's name and a destination, and a communication device 13 connected to a personal computer 12 in a game center 11.

The play portion 6 is suitably structured such that amusements having game properties can be enjoyed. Various kinds of games are conceivable. A game drive portion 14 is structured such that the game is played in accordance with the operation of an operation switch 15, and when the game is ended and the player obtains the right to acquire the prize 2, a duplicate slit (not shown) is released from an outlet 16.

The sample display portion 8 is formed to be a large plate which can be hung on a wall surface, panels (samples 7) displaying the prizes are arranged on the surface, and each of them is illuminated by an illumination device (not shown) from the back side. A suitable identification symbol 7a for identifying the prize, for example, “A107” in the example shown, together with the photograph of the prize 2, is affixed to the surface of the sample 7.

The selection means 9 outputs a prize selection signal (prize data) corresponding to the favorite prize 2 selected by the player among the plural kinds of samples 7 displayed on the sample display portion 8, and is constructed by a touch panel or the like, and the designation of the prize is carried out by the input of the identification symbol 7a.

The input means 10, together with the selection means, is constituted by the touch panel or the like, and the personal data of a player's name and the destination can be inputted in addition to the identification symbol.

Besides, the game machine 1 is connected with a coin processing device 17 which receives insertion of a coin as a consideration for the game and repays the coin it necessary.

The respective portions are controlled by a control portion 18. The control portion 18 includes a CPU, a ROM and a RAM, the CPU executes a control operation along a program stored in the ROM, and the RAM stores data necessary for the operation.

A host computer 19 of the management center 3 is connected to the personal computer 12 of the game center 11 through a suitable communication device such as a telephone line, receives the prize data and the personal data, and outputs stock data of the prize 2.

The host computer 19 of the management center 3 is further connected to a personal computer 21 of a warehouse 20 holding the prizes through a communication device such as a telephone line, outputs forwarding instructions to the personal computer 21 of the warehouse 20, and receives the stock data.

The personal computer 21 of the warehouse 20 concretely performs the forwarding in accordance with the instructions from the host computer 19, and suitably outputs the managed stock data.

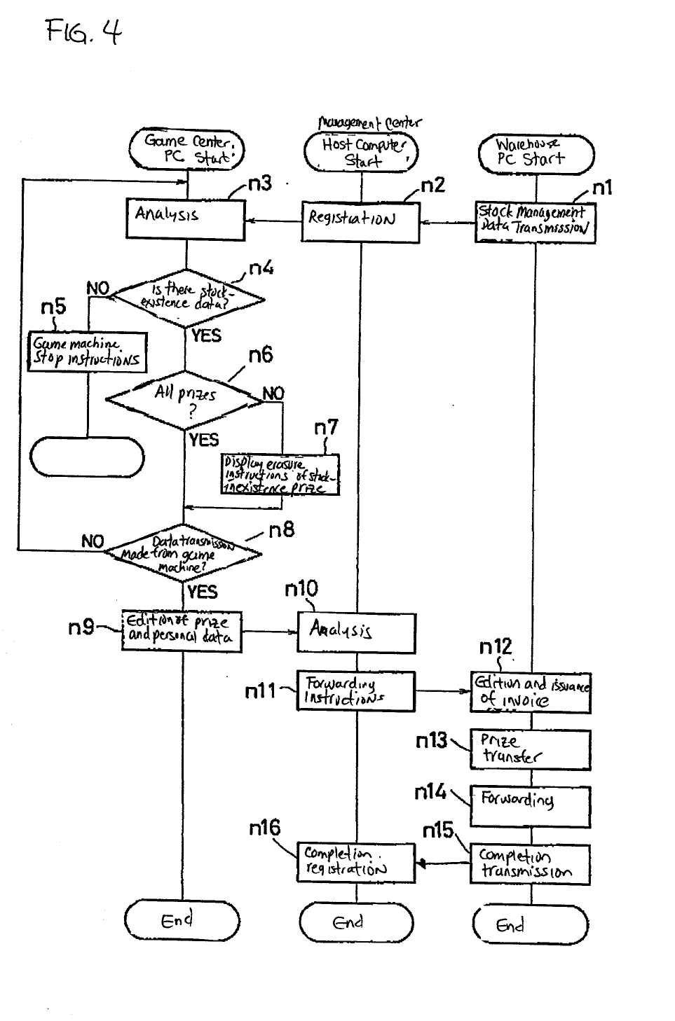

A way of providing the prize 2 in the prize providing system structured in this way will be described by use of a prize flowchart of FIG. 4.

First, the personal computer 21 of the warehouse 20 transmits the stock management data of the prizes to the host computer 19 of the management center 3 each time a change occurs (step n1). The host computer 19 registers the data (step n2), and transmits the data to the personal computer 12 of the game center 11. The personal computer 12 of the game center 11 analyzes the received stock management data (step n3), and judges whether or not there are stock-existence data (step n4). If the data do not exist, game machine stop instructions are issued and the game machine 1 is not driven (step n5).

In the case where the data exists at the step n4, it is judged whether or not the stock-existence data are for all prizes (step n6). If the data are not for all prizes, display erasure instructions of a stock-inexistence prize are issued (step n7), and the back side illumination means of the corresponding sample 7 of the sample display portion 8 is turned off.

Subsequently, the game is played and in the case where the player obtains the right to acquire the prize, and when the prize data and the personal data are transmitted from the game machine 1 (step n8), the personal computer 12 of the game center 11 edits the prize data and the personal data, and transmits the data to the host computer of the management center (step n9).

The host computer 19 of the management center 3 analyzes the received prize data and personal data (step n10), and transmits forwarding instructions together with the data (step n11).

The personal computer 21 of the warehouse 20 edits and issues an invoice on the basis of the received data (step n12). Then, the prize 2 corresponding to the prize data is taken out (step n13), and the invoice is affixed and the forwarding is performed (step n14).

Finally, the personal computer 21 of the warehouse 20 transmits the completion of the forwarding to the host computer 19 of the management center 3 (step n15), and the host computer 19 of the management center 3 registers the completion of the forwarding (step n16).

In the case where the prize 2 is sent to the home 4 of the player by the above forwarding, the player can receive the prize 2 in the home. In the case where the prize 2 is delivered to the convenience store 5 or the like desired by the player, the player receives the notification from the convenience store 5 or the like, and the player or his agent goes to the convenience store 5 to receive the prize while having the duplicate slip.

Like this r the actually provided prize 2 is not exhibited in the game machine 1, but is separately managed, so that the restriction to articles adopted as the prizes can be reduced. That is, its size, weight, and shape are free, and the number and kind of prizes can be freely increased. Thus, the game machine 1 which further arouses a desire for a game can be made. Besides, animals and plants can be treated as prizes without resistance.

Besides, since the player can select a favorite one among the kinds of prizes 2, a high satisfaction level to the prize 2 can be obtained.

Further, since the prizes 2 are separately managed, the operator (game center) side has only to manage the game machine itself, and the management load to the prizes can be greatly reduced.

Further, since the prizes 2 are delivered, the player is not required to have the burden when going home after the game, which is convenient.

Incidentally, the notification means in the present invention corresponds to the communication device 13 in the foregoing embodiment, and similarly, the transmission means corresponds to the communication device 13, and the forwarding processing portion corresponds to the host computer 19 of the management center 3 and the warehouse 20.

As described above, according to the present invention, the prizes to be acquired are not exhibited in the play portion of the game machine as in the prior art, but the sample display portion is provided and the prizes are displayed on the sample display portion, so that more kinds of prizes can be displayed as the prizes which can be acquired. Thus, the invention can be structured such that the player selects a favorite one among them, and a high feeling of satisfaction to the prize can be obtained. At the same time, the operator (game center) side has only to manage the game machine itself, and the management load to the prizes can be greatly reduced.

What is claimed is:

1. A game machine which provides a prize when a player plays a game and satisfies a definite condition, comprising:
a play portion where the player plays the game;
at the play portion, a sample display portion for displaying samples of plural kinds of prizes which can be acquired by the player; and
notification means for notifying a management center, which manages actually provided prizes, of an acquired prize chosen by the player when the player obtains a play result in accordance with which the prize can be acquired,

2. A game machine according to claim 1, further comprising, at the play portion, selection means for selecting the favorite prize among the plural samples displayed on the sample display portion and outputting a prize selection signal corresponding to the selected prize.

3. A game machine according to claim 1 or 2, further comprising, at the play portion, input means for inputting personal data of a player's name and a destination,
wherein the notification means is constituted by transmission means for transmitting the personal data inputted and recorded from the input means and data of the prize to be provided through a communication line.

4. A prize providing system, comprising a forwarding processing portion for performing, when the personal data and data of the prize to be provided are notified to the management center from the game machine as recited in any one of claims 1 to 3, a forwarding processing of the prize on the basis of the data.
